(19) United States
(12) Patent Application Publication
(10) Pub. No.: US 2024/0239531 A1
(43) Pub. Date: Jul. 18, 2024

(54) Compact and Lightweight Drone Delivery Device called an ArcSpear Electric Jet Drone System Having an Electric Ducted Air Propulsion System and Being Relatively Difficult to Track in Flight

(71) Applicant: Pete Bitar, Anderson, IN (US)

(72) Inventor: Pete Bitar, Anderson, IN (US)

(21) Appl. No.: 18/231,588

(22) Filed: Aug. 8, 2023

Related U.S. Application Data
(60) Provisional application No. 63/396,253, filed on Aug. 9, 2022.

(51) Int. Cl. B64U 50/30; B60L 50/60; B64U 10/14; B64U 30/26; B64U 50/19; B64U 101/18; H01M 50/204; H01M 50/249

(52) U.S. Cl. CPC B64U 50/30; B60L 50/60; B64U 10/14; B64U 30/26; B64U 50/19; H01M 50/204; H01M 50/249; B60L 2200/10; B64U 2101/18; H01M 2220/20

(57) ABSTRACT

A compact and lightweight, drone delivery device propelled by an electric ducted air propulsion system. The device is called an ArcSpear Electric Jet Drone System and is relatively difficult to track in flight (stealth), relatively fast, able to maneuver quickly, and able to be re-deployed after recharging and replenishing the payload. The system includes a frame carrying the propulsion system, payload, and controls. The frame structure supports a flight controller and a ducted turbine system with at least one and preferably four turbines the blades/impellers being secured inside a protection shroud/duct and individual electric motors that are powered by rechargeable batteries.

### CROSS-REFERENCE TO RELATED APPLICATIONS

This application claims the benefit of United States Provisional Patent Application with Ser. No. 63/396,253 filed Aug. 9, 2022, by Pete Bitar. The application is entitled “Special Small Drone Delivery Device called an ArcSpear Electric Jet Drone System Having an Electric Ducted Air Propulsion System and Being Relatively Difficult to Track in Flight”.

### FIELD OF INVENTION

This invention relates to a Compact and Lightweight drone delivery device called an ArcSpear Electric Jet Drone System having an electric ducted air propulsion system and being relatively difficult to track in flight. The invention relates generally to aircrafts, and more specifically, to an unmanned aerial vehicle (UAV) system and method of use. The present application relates to the field of unmanned aerial vehicle control technology, particularly, to an unmanned drone device capable of delivering payloads which can be secured to the device and has controllable flight powered by electrically powered ducted air as a propulsion arrangement. The invention relates generally to defense systems, and more specifically to an unmanned aerial vehicle with a weapons deployment or munitions carrier such as a grenade launcher.

### FEDERALLY SPONSORED RESEARCH

None.

### SEQUENCE LISTING OR PROGRAM

None.

### BACKGROUND—FIELD OF INVENTION and PRIOR ART

As far as known, there are no Compact and Lightweight drone delivery devices or the like such as an ArcSpear Electric Jet Drone System. It is believed that this product is unique in its design and technologies.

The success of traditional human transported weapons to hit intended targets has been dependent upon an individual warfighter's ability and skill to aim and control the weapon. Much training and practice is required to enable a warfighter to be skilled at marksmanship. Historically, a human transported weapon's accuracy has been limited to the operator's skill, as well as environmental factors that may obscure or complicate the shot. Because skill is involved with hitting a target with a human transported weapon, many of the shots will miss the intended target, placing a requirement of having a large supply of munitions available in a firelight. This places a burden to resupply the warfighter in the field, as well as for the warfighter to carry more munitions into a battle, which is extra weight, as well as extra cost. Consequentially, an unmanned aerial device that can carry a weapon or any small payload into an unfriendly area or area that is controlled by an adversary is a welcomed alternative to the human transported weapons.

The technology, development and deployment of small, unmanned air vehicles UAVs is becoming pervasive. Small UAVs provide a desirable and strategic sensor platform for close support operations including those associated with surveillance, reconnaissance, targeting, and battle damage assessment. In the hands of a military adversary, these small UAVs become a threat. They can be used defensively and offensively against assets and infrastructure deployed in the air, on the ground and on water. For example, fixed locations as well as moving armored and naval vessels are particularly vulnerable to small scale attack when underway or even while at port. Their low cost and ease of deployment have the potential to make them ubiquitously present in large numbers and in simultaneous mission scenarios.

The use of conventional manned aircraft, missiles, and larger unmanned aircraft to interdict small scale air, water and ground threats is an inefficient use of resources. Such a strategy puts human life at risk as well as equipment whose value may exceed the tactical value associated with interdiction. In addition, the use of conventional available resources inhibits these same resources from being used for more appropriate engagements. Arguably, the relatively long persistence required to detect and effectively track and interdict exceedingly small threats from small devices, especially where detection is conducted from the interdiction platform itself, often precludes the use of missiles and higher performance aircraft in general. In addition, certain missions, especially when of a clandestine nature, inherently demand “low-observability” features of small and fast devices since these same features are not commonly provided by more conventional interdiction platforms.

In a ‘fight fire with fire’ approach, a conventional small UAV might be used as an interdiction platform against an adversary's small UAV. However, the normal decision-making hierarchy, its necessary asset base and associated latent response time provide a sub-optimum response to the small UAV threat potential. From a technical perspective, small UAV platforms can be highly maneuverable. They provide close proximity to surface and objects desired for delivery of a payload by the small UAV operation or interdiction. The smaller also can offer devices that provide an effective weapons system that can be forgiving of small aiming errors. Conventional small UAVs and small surface craft have sufficient speed and maneuverability and can incorporate little awareness of the small aerial device to make it subject to traditional countermeasures. Moreover, small devices have heretofore lacked significant weapons capability. Those skilled in the art understand that more is required than the mere ad hock adaptation to retrofit conventional small UAVs with maneuverability and capacity for significant payload. Some of the fundamental issues presented in an effective small UAV interceptor design include appropriate weapon integration, torque management from weapon discharge, high G-force airframe design, the selection of track sensor technologies and intelligent (autonomous) maneuverability of the small UAV platform.

Accordingly, there is a recognized need for a small interceptor UAV, an associated weapon platform, a UAV avionics system, and a control methodology that addresses the challenges outlined above. A UAV airframe, weapons system, avionics system and method should provide for effective, autonomous management and execution of different mission scenarios. A small UAV should be highly integrated, relatively compact, and modular for ease of retrofit and portability and should be designed and constructed in a manner that maximizes survivability under demanding and hostile conditions. Devices and systems also benefit from being cost effective for application in large numbers to achieve parity against multiple and simultaneous threats.

### Problem Solved

The improvements and problems solved as to a Compact and Lightweight drone delivery device called an ArcSpear Electric Jet Drone System having an electric ducted air propulsion system and being relatively difficult to track in flight include: A. Is lighter weight due to lighter electric motors than gas-powered systems and lightweight, carbon fiber frame; B. Uses no combustible fuel—uses rechargeable batteries; C. Is quiet, no combustion noise, stealth; D. Is unmanned operation with remote controlled operation and Simple, servo-controller-based throttle to control Electronic Speed Controllers (ESCs) which drive electric motors; E. Capable of speed of up to 180 miles-per-hour {MPH}; F. Is a multi-copter with ducted fans, ducted turbines with protected intakes and more than one ducted fan/turbine arrayed with counter-rotating propellers/turbines; G. Has a small cross-section to deflect tracking signals and search beams. With such a small cross section and such a high speed, it would be able to fly low and between buildings and trees, making it nearly impossible to shoot down, unlike slower, comparable payload carrying drones that fly at less than 60 mph and have large propellers; H. Capable of rapid setup for launch and rapid start (no pull-starting, priming, or other pre-start actions needed to start the motor); I. Carries payloads of up to 20 pounds and 10 pounds of total aircraft weight; J. Operates with smooth, low-vibration operation; K. Uses commonly available drone stability using multiple gyroscopes with a standard multi-copter flight controller; L. Is relatively inexpensive so that it could be reused OR used just once, depending on mission requirements; M. Is safe to operate around with its ducted turbine blades; N. Can used be as a “poor man's Javelin missile”, flying at long distances (over 20 miles is possible) at high speed, then finding its target would shoot or drop its munitions on target; O. Controls allow automatically return home; P. Can be re-fitted with payloads for re-use; Q. Can be used effectively as a military asset, capable of deploying munitions against targets in a manner that allows for extreme control in congested urban, forested, or other confined environments, at high speed, with a cross-section and speed that would make it extremely difficult to shoot down; and

R. Utilizes electric jet turbine engines with 10:1 or greater thrust to weight ratio, such that for every one pound of engine plus ESC combined weight, the entire assembly produces at least 10 pounds of thrust. This would not include battery weight.

### PRIOR ART

As far as known, there are no devices for compact and lightweight drone delivery device called an Arc Spear having an electric ducted air propulsion system and being relatively difficult to track in flight as described by Pete Bitar. It is believed that this system or apparatus is unique in its design and technologies. A novelty search revealed:
A. US Patent Application US20210053695A1 by Marinus Bernard Bosma conceived in 2020 and called a Fire bomber delivery. Described here is a system for delivering fire retardant materials in fighting a surface fire is provided, having an aircraft carrying the fire-retardant material, a hose deployable from the aircraft, the delivery hose connected to the reservoir and having a controllable nozzle at a deployed end with a remotely operable valve, an end effector connected by a multi-axis gimbal at the deployed end of the delivery hose the end effector having fixed wings with ailerons and elevators, and a rudder, the ailerons, elevators and rudder moved by electrical actuators, and control apparatus and circuitry in the aircraft and the end effector enabling an operator in manipulating the ailerons, elevators and the rudder. An operative in the aircraft controls the end effector via the control apparatus to fly at a lower altitude and in a different path than the aircraft and opens the remotely operable valve to deliver the fire-retardant material from the delivery hose.
B. Chinese Patent CN106288963B which is assigned to Disco Corp and shown in 2016—entitles a Small-sized unmanned aerial vehicle driving and reversing device. Demonstrated and described is a compact unmanned aircraft retreating device is provided. When the small-sized unmanned aerial vehicle flies to an area that should be secured, the small-sized unmanned aerial vehicle is quickly knocked back (caught). The small unmanned aerial vehicle driving back device (1) comprises a capture body (2) for capturing an unmanned aerial vehicle as a capture object and a capture body transmitting device (3) for transmitting the capture body (2) towards the unmanned aerial vehicle, so that even if a suspicious unmanned aerial vehicle (6) flies to the area to be protected, the capture body (2) can be transmitted by the capture body transmitting device (3) to rapidly capture the unmanned aerial vehicle (6). Therefore, the benefit and safety of the benign nationality can be secured.
C. US Patent U.S. Pat. No. 9,180,967B2 was issued to Binkholder in 2012 called a Configurable pod structure and store stowage and deployment system and method. Taught here is an embodiment where there is provided a radar signature and induced aerodynamic drag minimizing, externally mountable, internally configurable pod structure optimized for internal placement of one or more deployable stores through configuration and optimal kinematic operation of a pod door assembly. The pod structure has an externally mountable pod housing, a predetermined pod housing cross-sectional configuration optimized to provide a configurable interior volume accommodating multiple different store configurations, and a predetermined pod housing configuration having a cross-sectional configuration optimized to minimize a radar signature and an induced aerodynamic drag. The pod structure further has a pod door assembly integral with the pod housing and having a plurality of pod doors and one or more seal door mechanism assemblies. The pod structure is optimized in kinematic operational combination of the pod doors and seal door mechanism assemblies controlling ejection launch envelopes.
D. US Patent U.S. Pat. No. 9,939,239B1 was issued to Manole in 2013 and titled a Stackable Collaborative engagement munition. This shows a stacked, collaborative engagement ammunition round is presented. The round includes plural stacked miniaturized projectiles where such projectiles separate after launch and then swarm as a group towards a target or targets. At launch, the projectiles may fly in a preselected formation, leader-follower towards the target. Or, the projectiles may deploy propellers, tri-copter or quad-copter vanes, and self-steer swarming to the target. Each projectile has its own miniaturized guidance, navigation and control components, autopilot, cameras, transmitter, receiver, antennae, power source, sensors, fuzes and/or flex circuits.
E. US Patent Appn. US 2018/0272856 made by Manning and named a Ducted Fan Propulsion System. Here is described an embodiment where a ducted fan propulsion system comprises an outer cowling, adapted to form a duct. The duct houses one or more fan blades rotating about a central axis. One or more motors are in communication with the fan blades and in communication with a power source. The duct is transversed by a plurality of spokes. In an embodiment, multiple ducts are housed within an outer cowling, with each duct comprising one or more rotatable fan blades, one or more central axes, and one or more motors. In each embodiment, one or more members are attached to the ducted or multi-ducted fan propulsion system and extend to a user or vehicle. The members terminate in a handle further comprising a throttle adjuster.
F. US Patent Application US 20190367169A1 published in 2019 by O'Leary and named an Unmanned flying grenade launcher. Provided in this application is an unmanned flying grenade launcher system is provided. The unmanned flying grenade launcher can include a portable unmanned aerial vehicle with an attachment apparatus configured to receive a standardized grenade launcher, and a servo coupled to adjust the angle of the grenade launcher relative to the portable unmanned aerial vehicle downward relative to the unmanned aerial vehicle. One or more telemetry systems can provide a visual indication of the unmanned aerial vehicle's surroundings to an operator and can receive flight commands and firing commands from the operator such that a firing mechanism fires the standardized grenade launcher in response to the firing command.
G. US Patent App. US 20070023582A1 by Steele made in 2005 and called an Unmanned air vehicle, integrated weapon platform, avionics system and control method. This shows a small, reusable interceptor unmanned air vehicle (UAV), an avionics control system for the UAV, a design method for the UAV and a method for controlling the UAV, for interdiction of small scale air, water and ground threats. The UAV includes a high performance airframe with integrated weapon and avionics platforms. Design of the UAV first involves the selection of a suitable weapon, then the design of the interceptor airframe to achieve weapon aiming via airframe maneuvering. The UAV utilizes an avionics control system that is vehicle-centric and, as such, provides for a high degree of autonomous control of the UAV. A situational awareness processor has access to a suite of disparate sensors that provide data for intelligently (autonomously) carrying out various mission scenarios. A flight control processor operationally integrated with the situational awareness processor includes a pilot controller and an autopilot controller for flying and maneuvering the UAV.

As can be observed, none of the prior art has anticipated or caused one skilled in the art of small, unmanned UAV drone devices to reason, consider, or conclude that this invention by Pete Bitar as obvious to a person having ordinary skill in the art of this industry. The device for a compact and lightweight drone delivery device called an Arc Spear having an electric ducted air propulsion system and being relatively difficult to track in flight provides an answer to the problems that are shown above. The Bitar solution addresses the shortfalls and solves them, unlike previous art in this industry.

### SUMMARY OF THE INVENTION

This invention is a Compact and Lightweight drone delivery device called an ArcSpear Electric Jet Drone System having an electric ducted air propulsion system and being relatively difficult to track in flight. Contemplated here is an electric turbine propelled multi-copter vertical takeoff and landing uncrewed aerial system.

The Compact and Lightweight drone delivery device called an ArcSpear Electric Jet Drone System having an electric ducted air propulsion system and being relatively difficult to track in flight has been described in the above embodiment. The manner of how the device operates is described below. One notes well that the description above and the operation described here must be taken together to fully illustrate the concept of the compact and lightweight drone delivery device called an ArcSpear Electric Jet Drone System. The preferred embodiment of the compact and lightweight, small drone delivery device called an ArcSpear Electric Jet Drone System comprised of: (a) a frame system; (b) a ducted turbine system comprising at least one and preferably four turbine with a set of blades or impellers of the fan/turbine, a shroud/exterior protection and frame of the turbine/fan, a cut protector on shroud, a means to secure shroud, and an electric motor with each fan the device with shaft connected to blades; (c) a payload with a deployment means on the structural frame; (d) a power system comprising a set of rechargeable batteries, a means to removably secure the batteries to the frame, a wiring harness from batteries to motors, a recharge plug to batteries from recharging power source, and a recharging power source; and (e) a flight controller for powering the ESC and controlling the motor plus a set of connectors from the set of batteries to the motor wherein the device having an electric ducted air propulsion system, being relatively difficult to track in flight (stealth), being relatively fast, able to maneuver quickly and able to re-use the device to repeat and carry payloads after recharging and replenishing the payload. The newly invented device called an ArcSpear Electric Jet Drone System can be manufactured at low volumes by quite simple means and in high volume production by more complex and controlled systems.

### OBJECTS AND ADVANTAGES

There are several objects and advantages (as well as related characteristics) of the small, compact, and lightweight drone delivery device called an ArcSpear Electric Jet Drone System having an electric ducted air propulsion system and being relatively difficult to track in flight. There are currently no known electric propulsion drone devices or systems that are effective at providing the objects of this invention. The ArcSpear Electric Jet Drone System is one that allows for the following benefits over conventional human powered or large conventional gas-powered or jet powered weapons and payload carrying systems and devices:

| Item | Advantages |
|---|---|
| 1 | Is lighter weight due to lighter electric motors |
| | than gas-powered systems and lightweight, carbon |
| | fiber frame (is 5 to 15 pounds and less than 1½ |
| | cubic feet); |
| 2 | Uses no combustible fuel - uses rechargeable |
| | batteries; |
| 3 | Is quiet, no combustion noise, stealth; |
| 4 | Is unmanned operation with remote controlled |
| | operation and Simple, servo-controller-based |
| | throttle to control Electronic Speed Controllers |
| | (ESCs) which drive electric motors; |
| 5 | Capable of speed of up to 180 miles-per-hour (MPH); |
| 6 | Is a multi-copter with ducted fans, ducted |
| | turbines with protected intakes and more than one |
| | ducted fan/turbine arrayed with counter-rotating |
| | propellers/turbines; |
| 7 | Has a small cross-section to deflect tracking |
| | signals and search beams. With such a small cross |
| | section and such a high speed, it would be able to |
| | fly low and between buildings and trees, making it |
| | nearly impossible to shoot down, unlike slower, |
| | comparable payload carrying drones that fly at |
| | less than 60 mph and have large propellers; |
| 8 | Capable of rapid setup for launch and rapid start |
| | (no pull-starting, priming, or other pre-start |
| | actions needed to start the motor); |
| 9 | Carries payloads of up to 20 pounds payload per 10 |
| | pounds of total aircraft weight (typical ArcSpear |
| | is 5 to 15 pounds and less than 1½ cubic feet); |
| 10 | Operates with smooth, low-vibration operation; |
| 11 | Uses commonly available drone stability using |
| | multiple gyroscopes with a standard multi-copter |
| | flight controller; |
| 12 | Is relatively inexpensive so that it could be |
| | reused OR used just once, depending on mission |
| | requirements; |
| 13 | Is safe to operate around with its ducted turbine |
| | blades; |
| 14 | Can be used as a “poor man's Javelin missile”, |
| | flying at long distances (over 20 miles is |
| | possible) at high speed, then finding its target |
| | would shoot or drop its munitions on target; |
| 15 | Controls allow automatically return home; |
| 16 | Can be re-fitted with payloads for re-use; |
| 17 | Can be used effectively as a military asset, |
| | capable of deploying munitions against targets in |
| | a manner that allows for extreme control in |
| | congested urban, forested, or other confined |
| | environments, at high speed, with a cross-section |
| | and speed that would make it extremely difficult |
| | to shoot down; and |
| 18 | Utilizes electric jet turbine engines with 10:1 or |
| | greater thrust to weight ratio, such that for |
| | every one pound of engine plus ESC combined |
| | weight, the entire assembly produces at least 10 |
| | pounds of thrust. This would not include battery weight. |

Finally, other advantages and additional features of the present Compact and Lightweight drone delivery device called an ArcSpear Electric Jet Drone System having an electric ducted air propulsion system and being relatively difficult to track in flight will be more apparent from the accompanying drawings and from the full description of the device. For one skilled in the art of small, unmanned aircraft, drones, and the like (for carrying various payloads including but not limited to weapons and munitions) it is readily understood that the features shown in the examples with this device and system are readily adapted to other types of unmanned electrical propulsion systems and devices.

### DESCRIPTION OF THE DRAWINGS—FIGURES

The accompanying drawings, which are incorporated in and constitute a part of this specification, illustrate an embodiment of the compact and lightweight drone delivery device called an ArcSpear Electric Jet Drone System having an electric ducted air propulsion system and being relatively difficult to track in flight that is preferred. The drawings together with the summary description given above and a detailed description given below explain the principles of the ArcSpear Electric Jet Drone (ArcSpear). It is understood, however, that the ArcSpear system is not limited to only the precise arrangements and instrumentalities shown.

FIGS. 1A through 1 C are sketches of the general compact and lightweight drone delivery device called an ArcSpear Electric Jet Drone System and the tactical process.

FIGS. 2A and 2 B are sketches of the compact and lightweight drone delivery device called an ArcSpear Electric Jet Drone System from different views with components and features noted.

FIGS. 3A and 3 B are more sketches of the compact and lightweight drone delivery device called an ArcSpear Electric Jet Drone System from different views with components and features noted.

FIGS. 4A through 4 E are views of the compact and lightweight drone delivery device called an ArcSpear Electric Jet Drone System and top views of the frame of the ArcSpear device. Also shown are methods to group propulsion systems with multiple systems to propel an operator by harnessing several systems.

FIGS. 5A through 5 C are sketches of the quick-change propulsion battery pack and the compact and lightweight drone delivery device called an ArcSpear Electric Jet Drone System in flight.

FIGS. 6A through 6 D are up close drawings of the propulsion system fan systems and wiring harnesses of the control accessories.

FIGS. 7A through 7 C are sketches of the control and wiring systems, the operator with goggles and controller, and the typical controller for the compact and lightweight drone delivery device called an ArcSpear Electric Jet Drone System.

FIGS. 8A through 8 D are sketches of an ArcSpear device in operation and the tactical process.

FIGS. 9A through 9 F are sketches of prior art for ArcSpear Electric Jet Drone System.

### DESCRIPTION OF THE DRAWINGS—REFERENCE NUMERALS

The following list refers to the drawings:

TABLE B
Reference numbers -

| Ref # | Description |
|---|---|
| 30 | compact and lightweight drone delivery device 30 |
| | called an ArcSpear Electric Jet Drone System having |
| | an electric ducted air propulsion system and being |
| | relatively difficult to track in flight |
| 31 | prototype 31 of compact and lightweight drone |
| | delivery device 30 called an ArcSpear Electric Jet |
| | Drone System |
| 33 | flight 33 of the prototype 31 of the ArcSpear |
| | Electric Jet Drone System 30 |
| 35 | tactical process 35 of the |
| | compact and lightweight drone delivery device 30 |
| | called an Arc Spear |
| 50 | turbine electric fan 50 of the drone delivery device |
| | called an ArcSpear Electric Jet Drone System 30 |
| 51 | blades or impellers 51 of fan/turbine 50 |
| 55 | shroud/exterior protection and frame 55 of the |
| | turbine/fan 50 |
| 55A | cut protector 55A on shroud 55 |
| 56 | means 56 to secure shroud 55 and support 59 to frame |
| | 71 |
| 58 | group of shafts, motor cone, and bearings 58 of |
| | turbine 50 |
| 59 | axial supports and motor support ring 59 |
| 59A | means to connect/ fasten 59A shroud 55 to turbine |
| | electric fan 50 and motor 78 |
| 59B | means to connect together 59B shroud 55, supports and |
| | ring 59 such as fasteners, molding, casting, welding, |
| | brazing, adhesives, or the like |
| 71, 71A | frame 71 supporting the fans 50 and shrouds 55 and |
| | motors 78; supporting the payload 110; supporting the |
| | batteries 74; and supporting the wiring harnesses 76, |
| | flight controller 80, ESCs 90, and other accessories |
| | and controls; frame 71A is frame 71 with top mount of |
| | payload 110 - frames 71, 71A made of light weight and |
| | very strong and durable composite materials with |
| | carbon microfibers or like materials |
| 72 | a means for connecting 72 platform 70 and structure |
| | 71 - fasteners, clips, rings, cable ties, adhesives, |
| | weld, braze, or cold casting as one piece |
| 74 | set of rechargeable batteries 74 |
| 75 | battery boxes 75 |
| 75A | battery block 75A connecting set of batteries 74 to |
| | ESC 90 |
| 76 | wiring harnesses 76 from batteries 74 to block 75A to |
| | ESC 90 to motors 78 |
| 77 | means for removably connecting 77 battery box 75 and |
| | wiring harnesses 76 to frame 71 - fasteners, clips, |
| | rings, cable ties, adhesives |
| 78 | electric motor 78 of the compact and lightweight |
| | drone delivery device 30 with shaft 58 connected to |
| | blades 51 |
| 79 | recharge plug 79 to rechargeable batteries 74 from |
| | recharging power source 89 |
| 80 | flight controller 80 |
| 81 | antennas 81 for receiving and sending signals from |
| | flight controller 80 to and from control console 95 |
| | at operator 100 and to and from camera 82 to 3-D |
| | goggles 92 of operator 100 and for |
| 82 | camera 82 |
| 83 | wiring cable/conduction/harness 83 |
| 85 | connectors 85 from batteries 75 to motor 78 |
| 86 | means for connecting 86 cables 83 and connectors 85 |
| | to structure 71 - fasteners, clips, rings, cable |
| | ties, adhesives |
| 89 | recharging power source 89 to utility receptacle, |
| | solar panels on ground stand, or wired system |
| | generator |
| 90 | Electrical Speed Controller (ESC) 90 to control power |
| | from batteries 74 and block 75A sent to motors 78 of |
| | fan 50 |
| 91 | transceivers 91 and other electronic controllers 91A |
| 92 | 3-D goggles 92 of operator 100 with signals to/from |
| | camera 82 |
| 95 | control console 95 at operator 100 with signals |
| | to/from flight controller 80 which controls the ESCs |
| | 90 and the controls 115 of the payload 100 |
| 100 | user/operator 100 of the compact and lightweight |
| | drone delivery device called an ArcSpear Electric Jet |
| | Drone System 30 |
| 105 | ArcSpear Electric Jet Drone System 30 |
| 110 | payload 110 which can be various goods 110A like |
| | medicine, food, ammunition, field supplies; weapons |
| | and munitions 110B such as explosives, grenades, |
| | rockets, tube bombs, timed discharge devices, and |
| | electronic interference devices 110C and the like |
| 111 | aperture 111 for payload 110 |
| 112 | apertures and tabs 112 for payload 110 |
| 115 | controls 115 to remotely release payload 110 or |
| | operate payload devices |
| 120 | ground or terrain being flown above by ArcSpear |
| | device 30 |
| 125 | wiring and general control sketches 125 |
| 130 | flight path 130 of the ArcSpear device 30 in the |
| | tactical process 35 |
| 140 | quick change propulsion pack 140 with multiple |
| | batteries 74 secured around the fan shrouds 55 of |
| | fans 50 |
| 141 | tabs 141 to connect means to secure batteries 74 and |
| | belt 146 to shroud 55 |
| 145 | means 145 to secure and hold batteries 74 and belt |
| | 146 around shroud 55 such as a flexible belt 146 with |
| | pockets to hold batteries 74 and fastening buckle |
| | 146A such as a utility belt or equal |
| 146 | flexible belt 146 with pockets to hold batteries 74 |
| | and fastening buckle 146A |
| 147 | aperture/opening 147 for fan 50 |
| 148 | mounting tabs and opening 148 for means to connect 56 |
| | shroud 55 to fans 50 |
| 149 | aperture/opening 149 for connecting ESC 90, |
| | controllers 80, camera 82, and accessories to frame |
| | 71 |
| 150 | target or destination 150 of the payload 110 of the |
| | ArcSpear device 30 |
| 300 | prior Art 300 US20210053695A1 - Marinus Bernard Bosma |
| | 2020 - Fire bomber delivery |
| 310 | prior Art 310 CN106288963B - Disco Corp - 2016 - |
| | Small-sized unmanned aerial vehicle driving and |
| | reversing device |
| 320 | prior Art 320 U.S. Pat. No. 9,180,967 B2 - Binkholder - |
| | 2012 - Configurable pod structure and store stowage and |
| | deployment system and method |
| 330 | prior Art 330 U.S. Pat. No. 9,939,239 B1 - Manole - 2013 - |
| | Stackable Collaborative engagement munition |
| 340 | prior Art 340 US Patent Appn. 2018/0272856 Manning - |
| | 2018 DUCTED FAN PROPULSION SYSTEM |
| 350 | prior Art 350 US Patent Appn. US 20190367169A1 |
| | 2019 -O'Leary Unmanned flying grenade launcher |

### DETAILED DESCRIPTION OF PREFERRED EMBODIMENT

This invention relates to compact and lightweight drone delivery device called an ArcSpear Electric Jet Drone System having an electric ducted air propulsion system and being relatively difficult to track in flight. The invention relates generally to aircrafts, and more specifically, to an unmanned aerial vehicle (UAV) system and method of use. The present application relates to the field of unmanned aerial vehicle control technology, particularly, to an unmanned drone device capable of delivering payloads which can be secured to the device and has controllable flight powered by electrically powered ducted air as a propulsion arrangement. The invention relates generally to defense systems, and more specifically to an unmanned aerial vehicle with a weapons deployment or munitions carrier such as a grenade launcher.

The advantages and related characteristics for a compact and lightweight drone delivery device called an ArcSpear Electric Jet Drone System 30 are listed above in the introduction. Succinctly the benefits are that the device:
A. Is lighter weight due to lighter electric motors than gas-powered systems and lightweight, carbon fiber frame (is 5 to 15 pounds and less than 1½ cubic feet);
B. Uses no combustible fuel—uses rechargeable batteries;
C. Is quiet, no combustion noise, stealth;
D. Is unmanned operation with remote controlled operation and Simple, servo-controller-based throttle to control Electronic Speed Controllers (ESCs) which drive electric motors;
E. Capable of speed of up to 180 miles-per-hour {MPH};
F. Is a multi-copter with ducted fans, ducted turbines with protected intakes and more than one ducted fan/turbine arrayed with counter-rotating propellers/turbines;
G. Has a small cross-section to deflect tracking signals and search beams. With such a small cross section and such a high speed, it would be able to fly low and between buildings and trees, making it nearly impossible to shoot down, unlike slower, comparable payload carrying drones that fly at less than 60 mph and have large propellers;
H. Capable of rapid setup for launch and rapid start (no pull-starting, priming, or other pre-start actions needed to start the motor);
I. Carries payloads of up to 20 pounds payload per 10 of total aircraft weight (typical ArcSpear is 5 to 15 pounds and less than 1½ cubic feet);
J. Operates with smooth, low-vibration operation;
K. Uses commonly available drone stability using multiple gyroscopes with a standard multi-copter flight controller;
L. Is relatively inexpensive so that it could be reused OR used just once, depending on mission requirements;
M. Is safe to operate around with its ducted turbine blades;
N. Can be used as a “poor man's Javelin missile”, flying at long distances (over 20 miles is possible) at high speed, then finding its target would shoot or drop its munitions on target;
O. Controls allow automatically return home;
P. Can be re-fitted with payloads for re-use;
Q. Can be used effectively as a military asset, capable of deploying munitions against targets in a manner that allows for extreme control in congested urban, forested, or other confined environments, at high speed, with a cross-section and speed that would make it extremely difficult to shoot down; and
R. Utilizes electric jet turbine engines with 10:1 or greater thrust to weight ratio, such that for every one pound of engine plus ESC combined weight, the entire assembly produces at least 10 pounds of thrust. This would not include battery weight.

The compact and lightweight drone delivery device 30 called an ArcSpear Electric Jet Drone System having an electric ducted air propulsion system and being relatively difficult to track in flight has been described in the above embodiment. The manner of how the device operates is described below. One notes well that the description above and the operation described here must be taken together to fully illustrate the concept of the compact and lightweight drone delivery device called an ArcSpear Electric Jet Drone System. The preferred embodiment of the compact and lightweight drone delivery device 30 called an ArcSpear Electric Jet Drone System comprised of: (a) a frame system 71; (b) a ducted turbine system comprising at least one and preferably four turbine 50 with a set of blades or impellers 51 of the fan/turbine 50, a shroud/exterior protection and frame 55 of the turbine/fan 50, a cut protector 55A on shroud 55, a means 56 to secure shroud 55, and an electric motor 78 with each fan 50 the device 30 with shaft 58 connected to blades 51; (c) a payload 110 with a deployment means 115 on the structural frame 71; (d) a power system comprising a set of rechargeable batteries 74, a means to removably secure the batteries 74 to the frame 71, a wiring harness from batteries 74 to motors 78, a recharge plug 79 to batteries 74 from recharging power source 89, and a recharging power source 89; and (e) a flight controller 80 for powering the ESC 90 and controlling the motor 78 plus a set of connectors 85 from the set of batteries 74 to the motor 78 wherein the device 30 having an electric ducted air propulsion system, being relatively difficult to track in flight (stealth), being relatively fast, able to maneuver quickly and able to refuse the device to repeat and carry payloads after recharging and replenishing the payload.

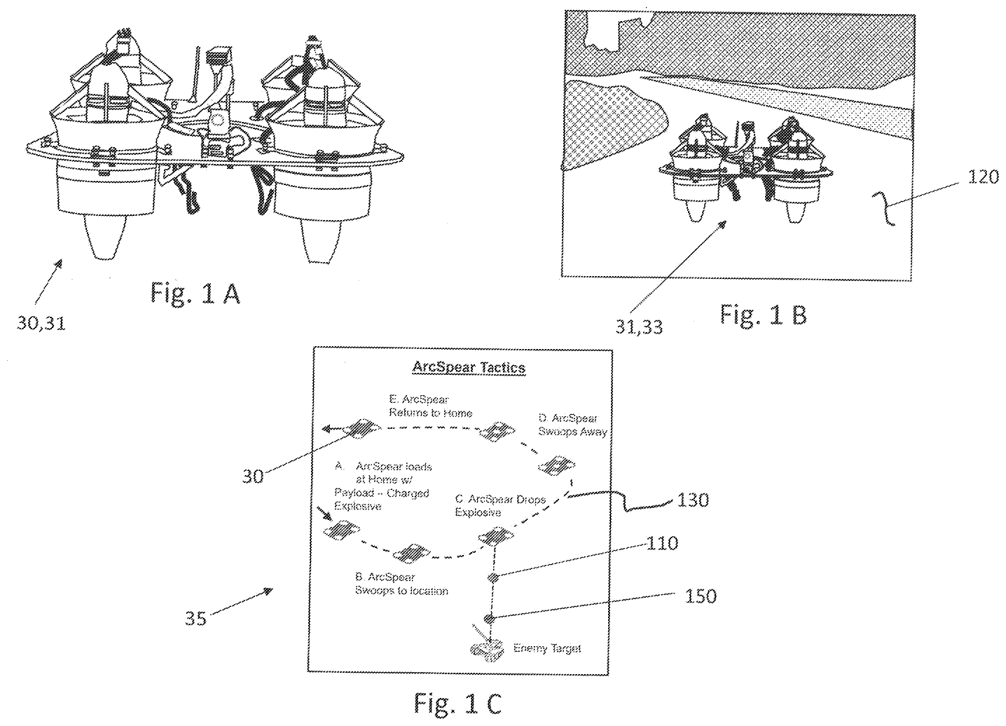

There is shown in FIGS. 1-9 a complete description and operative embodiment of the compact and lightweight drone delivery device 30 called an ArcSpear Electric Jet Drone System having an electric ducted air propulsion system and being relatively difficult to track in flight. In the drawings and illustrations, one notes well that the FIGS. 1-9 demonstrate the general configuration and use of this product. The various example uses are in the operation and use section, below.

The accompanying drawings, which are incorporated in and constitute a part of this specification, illustrate an embodiment of the compact and lightweight drone delivery device 30 called an ArcSpear Electric Jet Drone System that is preferred. The drawings together with the summary description given above and a detailed description given below explain the principles of the device 30. It is understood, however, that the device 30 called an ArcSpear Electric Jet Drone System having an electric ducted air propulsion system is not limited to only the precise arrangements and instrumentalities shown. Other examples of propulsion systems for small aircraft are still understood by one skilled in the art of this industry to be within the scope and spirit shown here.

FIGS. 1A through 1 C are sketches of the general compact and lightweight drone delivery device 30 called an ArcSpear Electric Jet Drone System and the tactical process 35. Shown in these sketches and drawings are: a compact and lightweight drone delivery device 30 called an ArcSpear Electric Jet Drone System having an electric ducted air propulsion system and being relatively difficult to track in flight; a prototype 31 of compact and lightweight drone delivery device 30 called an ArcSpear Electric Jet Drone System; a flight 33 of the prototype 31 of the ArcSpear Electric Jet Drone System 30; a tactical process 35 of the compact and lightweight drone delivery device 30 called an Arc Spear; a payload 110 which can be various goods 110A like medicine, food, ammunition, field supplies; weapons and munitions 110B such as explosives, grenades, rockets, tube bombs, timed discharge devices, and electronic interference devices 110C and the like; the ground or terrain 120 being flown above by ArcSpear device 30; a flightpath 130 of the ArcSpear device 30 in the tactical process 35; and a target or destination 150 of the payload 110 of the ArcSpear device 30.

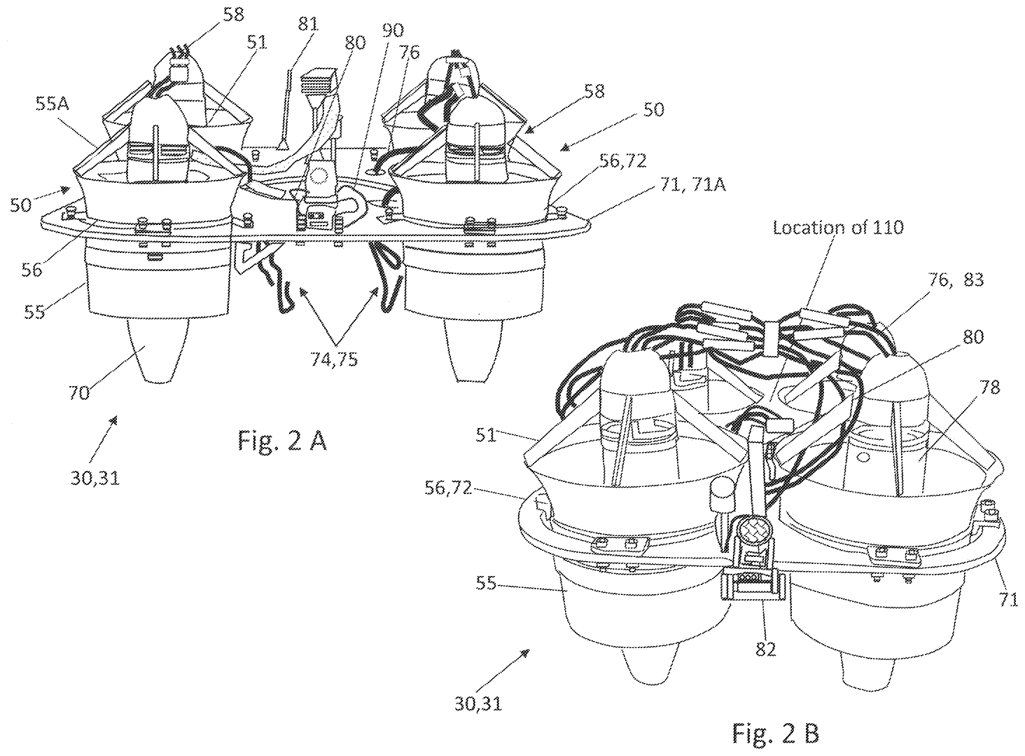

FIGS. 2A and 2 B are sketches of the compact and lightweight drone delivery device 30 called an ArcSpear Electric Jet Drone System from different views with components and features noted. Provided in these drawings are: a compact and lightweight drone delivery device 30 called an ArcSpear Electric Jet Drone System having an electric ducted air propulsion system and being relatively difficult to track in flight; a prototype 31 of compact and lightweight drone delivery device 30 called an ArcSpear Electric Jet Drone System; a set of blades or impellers 51 of fan/turbine 50; a shroud/exterior protection and frame 55 of the turbine/fan 50; a cut protector 55A on shroud 55; a means 56 to secure shroud 55 and support 59 to frame 71; a group of shafts, motor cone, and bearings 58 of turbine 50; an axial supports and motor support ring 59; a means to connect/fasten 59A shroud 55 to a turbine electric fan 50 and motor 78; a means to connect together 59B shroud 55, supports and ring 59 such as fasteners, molding, casting, welding, brazing, adhesives, or the like; a frame 71 supporting the fans 50 and shrouds 55 and motors 78; supporting the payload 110; supporting the batteries 74; and supporting the wiring harnesses 76, flight controller 80, ESCs 90, and other accessories and controls-frames 71 made of light weight and very strong and durable composite materials with carbon micro fibers or like materials; a means for connecting 72 platform 70 and structure 71—fasteners, clips, rings, cable ties, adhesives, weld, braze, or cold/casting as one piece; a set of rechargeable batteries 74; a set of battery boxes 75; a wiring harnesses 76 from batteries 74 to block 75A to ESC 90 to motors 78; a means for removably connecting 77 battery box 75 and wiring harnesses 76 to frame 71—fasteners, clips, rings, cable ties, adhesives; an electric motor 78 of the compact and lightweight drone delivery device 30 with shaft 58 connected to blades 51; a flight controller 80; a set of antennas 81 for receiving and sending signals from flight controller 80 to and from control console 95 at operator 100 and to and from camera 82 to 3-D goggles 92 of operator 100; a camera 82; a wiring cable/conduction/harness 83; a set of connectors 85 from batteries 75 to motor 78; a means for connecting 86 cables 83 and connectors 85 to structure 71—fasteners, clips, rings, cable ties, adhesives; a set of Electrical Speed Controller (ESC) 90 to control power from batteries 74 and block 75A sent to motors 78 of fan 50; and a payload 110 which can be various goods 110A like medicine, food, ammunition, field supplies; weapons and munitions 110B such as explosives, grenades, rockets, tube bombs, timed discharge devices, and electronic interference devices 110C and the like.

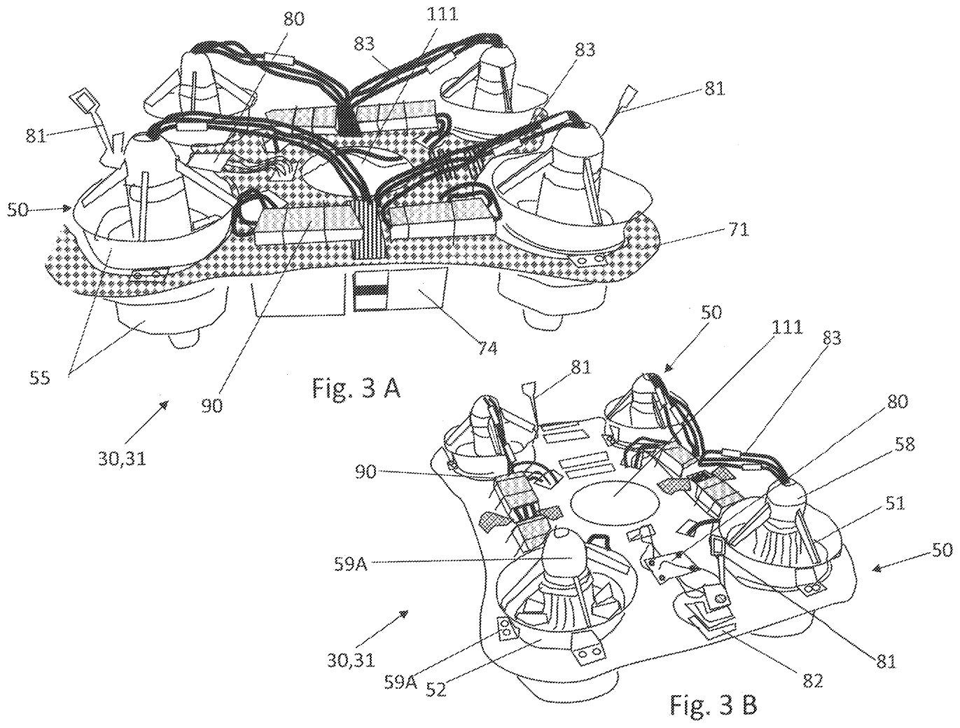

FIGS. 3A and 3B are more sketches of the compact and lightweight drone delivery device 30 called an ArcSpear Electric Jet Drone System from different views with components and features noted. Demonstrated here are: a compact and lightweight drone delivery device 30 called an ArcSpear Electric Jet Drone System having an electric ducted air propulsion system and being relatively difficult to track in flight; a prototype 31 of compact and lightweight drone delivery device 30 called an ArcSpear Electric Jet Drone System; a set of blades or impellers 51 of fan/turbine 50; a shroud/exterior protection and frame 55 of the turbine/fan 50; a cut protector 55A on shroud 55; a means 56 to secure shroud 55 and support 59 to frame 71; a group of shafts, motor cone, and bearings 58 of turbine 50; an axial supports and motor support ring 59; a means to connect/fasten 59A shroud 55 to a turbine electric fan 50 and motor 78; a means to connect together 59B shroud 55, supports and ring 59 such as fasteners, molding, casting, welding, brazing, adhesives, or the like; a frame 71 supporting the fans 50 and shrouds 55 and motors 78; supporting the payload 110; supporting the batteries 74; and supporting the wiring harnesses 76, flight controller 80, ESCs 90, and other accessories and controls-frames 71 made of light weight and very strong and durable composite materials with carbon micro fibers or like materials; a means for connecting 72 platform 70 and structure 71—fasteners, clips, rings, cable ties, adhesives, weld, braze, or cold/casting as one piece; a set of rechargeable batteries 74; a set of battery boxes 75; a wiring harnesses 76 from batteries 74 to block 75A to ESC 90 to motors 78; a means for removably connecting 77 battery box 75 and wiring harnesses 76 to frame 71—fasteners, clips, rings, cable ties, adhesives; an electric motor 78 of the drone delivery device 30 with shaft 58 connected to blades 51; a recharge plug 79 to rechargeable batteries 74 from recharging power source 89; a flight controller 80; a set of antennas 81 for receiving and sending signals from flight controller 80 to and from control console 95 at operator 100 and to and from camera 82 to 3-D goggles 92 of operator 100; a camera 82; a wiring cable/conduction/harness 83; a set of connectors 85 from batteries 75 to motor 78; a means for connecting 86 cables 83 and connectors 85 to structure 71—fasteners, clips, rings, cable ties, adhesives; a set of Electrical Speed Controller (ESC) 90 to control power from batteries 74 and block 75A sent to motors 78 of fan 50; and a payload 110 which can be various goods 110A like medicine, food, ammunition, field supplies; weapons and munitions 110B such as explosives, grenades, rockets, tube bombs, timed discharge devices, and electronic interference devices 110C and the like.

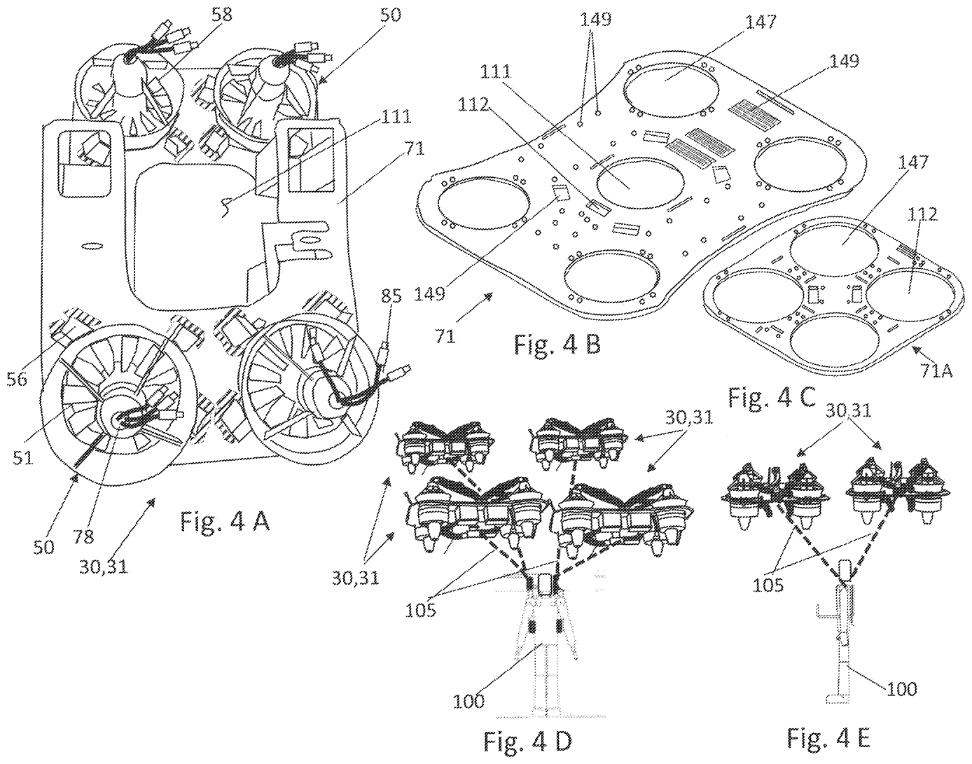

FIGS. 4A through 4 E are top of the compact and lightweight drone delivery device called an ArcSpear Electric Jet Drone System 30 and top views of the frame 71 of the ArcSpear device. Also shown are methods to group propulsion systems with multiple systems to propel an operator by harnessing several systems. Shown in these views are the following: a compact and lightweight drone delivery device 30 called an ArcSpear Electric Jet Drone System having an electric ducted air propulsion system and being relatively difficult to track in flight; a prototype 31 of compact and lightweight drone delivery device 30 called an ArcSpear Electric Jet Drone System; a turbine electric fan 50 of the special compact and lightweight delivery device called an ArcSpear Electric Jet Drone System 30; a set of blades or impellers 51 of fan/turbine 50; a shroud/exterior protection and frame 55 of the turbine/fan 50; a means 56 to secure shroud 55 and support 59 to frame 71; a group of shafts, motor cone, and bearings 58 of turbine 50; an axial supports and motor support ring 59; a means to connect/fasten 59A shroud 55 to turbine electric fan 50 and motor 78; a frame 71 supporting the fans 50 and shrouds 55 and motors 78; frame 71 with top mount of payload 110—frames 71, 71A made of light weight and very strong and durable composite materials with carbon micro fibers or like materials; an aperture 111 for payload 110; an set of apertures and tabs 112 for payload 110; an aperture/opening 147 for fan 50; a set of tabs and opening 148 for means to connect 56 shroud 55 to fans 50; and an aperture/opening 149 for connecting ESC 90, controllers 80, camera 82, and accessories to frame 71. FIGS. 4 D and E depict a connection of a harness 105 to several clusters of the ArcSpear Electric Jet Drone System 30. ArcSpear can be used for personal, human transportation in swarms that connect to specially crafted harnesses with frames that allow multiple 4, 6, 8 or more-engined ArcSpears to link together on a harness-mounted frame, and lift an individual into the air, as a single, controllable, on-demand, personal Jetpack or other configuration, including that of something resembling a flying car that could carry more than one person. It is effectively utilizing the unexposed nature of ArcSpear's Propulsion to closely couple swarms of them to provide effective, human transport. Many drone swarms are used today in light shows and other displays, but they must maintain several body lengths of distance from each other because most are open-propeller driven. Because ArcSpear encapsulates its propulsion, swarming can allow close coupling of multiple 6 aircraft together to provide clustered Propulsion for human or even heavy payload transport.

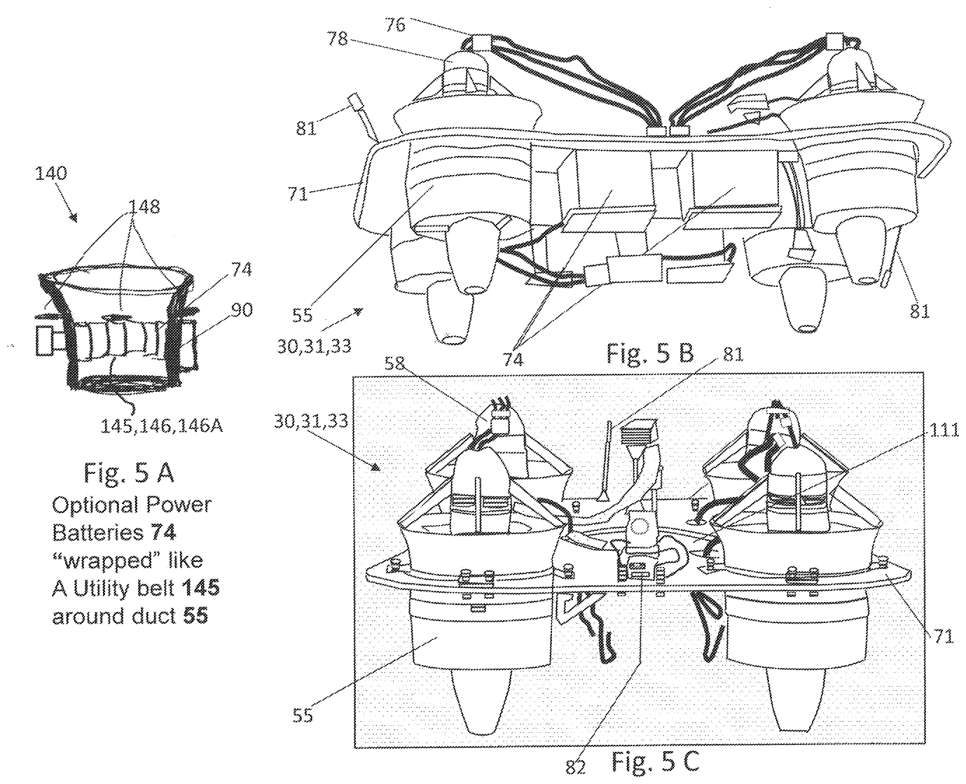

FIGS. 5A through 5 C are sketches of the quick-change propulsion battery pack 140 and the compact and lightweight drone delivery device 3,31 called an ArcSpear Electric Jet Drone System in flight 33. Provided here are: a compact and lightweight drone delivery device 30 called an ArcSpear Electric Jet Drone System having an electric ducted air propulsion system and being relatively difficult to track in flight; a prototype 31 of compact and lightweight drone delivery device 30 called an ArcSpear Electric Jet Drone System; a flight 33 of the prototype 31 of the ArcSpear Electric Jet Drone System 30; a turbine electric fan 50 of the compact and lightweight drone delivery device called an ArcSpear Electric Jet Drone System 30; a set of blades or impellers 51 of fan/turbine 50; a shroud/exterior protection and frame 55 of the turbine/fan 50; a frame 71 supporting the fans 50 and shrouds 55 and motors 78; supporting the payload 110; supporting the batteries 74; and supporting the wiring harnesses 76, flight controller 80, ESCs 90, and other accessories and controls; frames 71 made of light weight and very strong and durable composite materials with carbon micro fibers or like materials; a set of rechargeable batteries 74; a wiring harnesses 76 from batteries 74 to block 75A to ESC 90 to motors 78; a flight controller 80; a set of antennas 81 for receiving and sending signals from flight controller 80 to and from control console 95 at operator 100 and to and from camera 82 to 3-D goggles 92 of operator 100; a camera 82; a wiring cable/conduction/harness 83; a set of Electrical Speed Controller (ESC) 90 to control power from batteries 74 and block 75A sent to motors 78 of fan 50; a quick-change propulsion pack 140 with multiple batteries 74 secured around the fan shrouds 55 of fans 50; a set of tabs 141 to connect means to secure batteries 145 and the batteries 74 to the shroud 55 such as a utility belt or equal; a means 145 to secure and hold batteries 74 around shroud 55 such as a flexible belt 146 with pockets to hold batteries 74 and fastening buckle 146A; and a flexible belt 146 with pockets to hold batteries 74 and fastening buckle 146A.

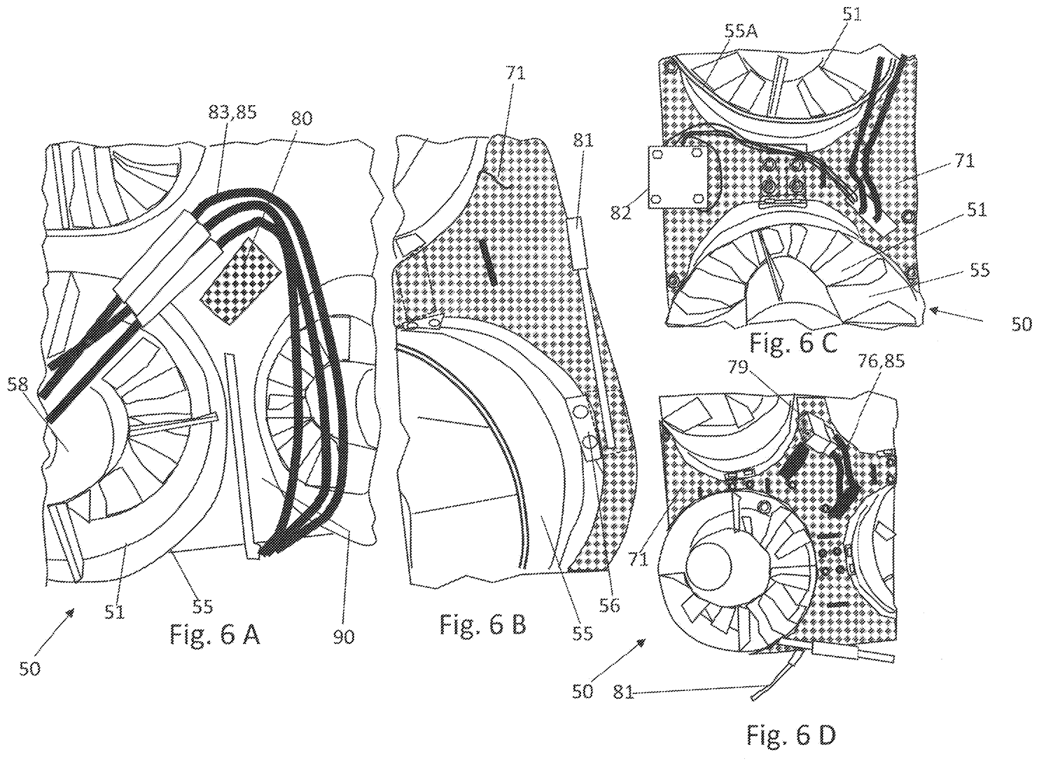

FIGS. 6A through 6 D are up close drawings of the propulsion system fan systems and wiring harnesses of the control accessories. Demonstrated are: a turbine electric fan 50 of the compact and lightweight drone delivery device called an ArcSpear Electric Jet Drone System 30; a set of blades or impellers 51 of fan/turbine 50; a shroud/exterior protection and frame 55 of the turbine/fan 50; a means 56 to secure shroud 55 and support 59 to frame 71; a group of shafts, motor cone, and bearings 58 of turbine 50; an axial supports and motor support ring 59; a means to connect/fasten 59A shroud 55 to turbine electric fan 50 and motor 78; a means to connect together 59B shroud 55, supports and ring 59 such as fasteners, molding, casting, welding, brazing, adhesives, or the like; a frame 71 supporting the fans 50 and shrouds 55 and motors 78; a recharge plug 79 to rechargeable batteries 74 from recharging power source 89; a flight controller 80; a set of antennas 81 for receiving and sending signals from flight controller 80 to and from control console 95 at operator 100 and to and from camera 82 to 3-D goggles 92 of operator 100; a camera 82; a wiring cable/conduction/harness 83; a set of connectors 85 from batteries 75 to motor 78; a means for connecting 86 cables 83 and connectors 85 to structure 71—fasteners, clips, rings, cable ties, adhesives; and a set of Electrical Speed Controller (ESC) 90 to control power from batteries 74 and block 75A sent to motors 78 of fan 50.

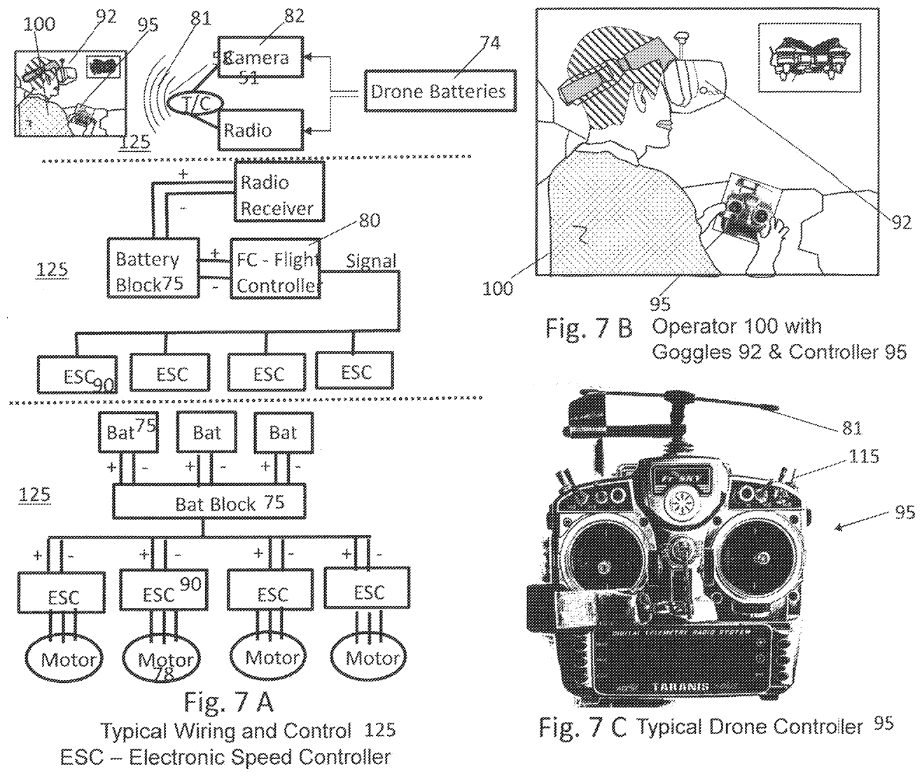

FIGS. 7A through 7 C are sketches of the control and wiring systems 125, the operator 100 with goggles 92 and controller 95, and the typical controller 95 for the compact and lightweight drone delivery device 30 called an ArcSpear Electric Jet Drone System. In these drawings on sees: a set of rechargeable batteries 74; a battery block 75A connecting set of batteries 74 to ESC 90; a wiring harnesses 76 from batteries 74 to block 75A to ESC 90 to motors 78; a flight controller 80; a set of antennas 81 for receiving and sending signals from flight controller 80 to and from control console 95 at operator 100 and to and from camera 82 to 3-D goggles 92 of operator 100; a camera 82; a wiring cable/conduction/harness 83; a set of connectors 85 from batteries 75 to motor 78; a set of Electrical Speed Controller (ESC) 90 to control power from batteries 74 and block 75A sent to motors 78 of fan 50; a transceiver 91 and other electronic controllers 91A; a pair of 3-D goggles 92 of operator 100 with signals to/from camera 82; control console 95 at operator 100 with signals to/from flight controller 80 which controls the ESCs 90 and the controls 115 of the payload 100; an user/operator 100 of the compact and lightweight drone delivery device called an ArcSpear Electric Jet Drone System 30; a set of controls 115 to remotely release payload 110 or operate payload devices; and a group of wiring and general control sketches 125.

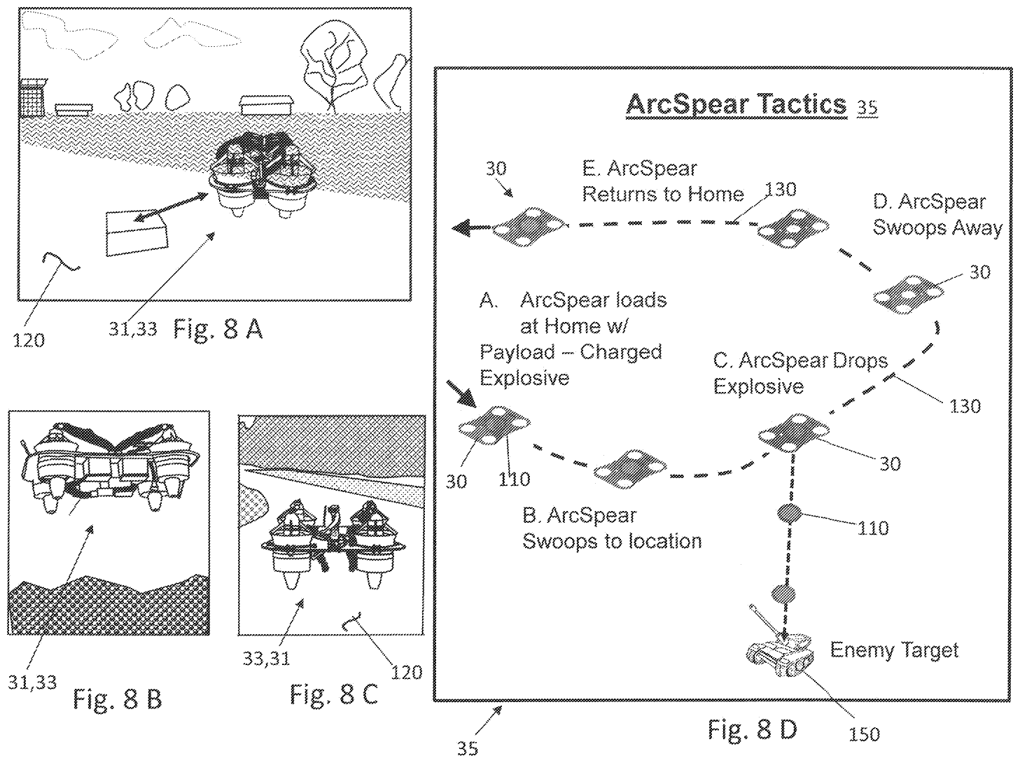

FIGS. 8A through 8 D are sketches of an ArcSpear device in operation and the tactical process. These drawings are discussed in the Operations section, below.

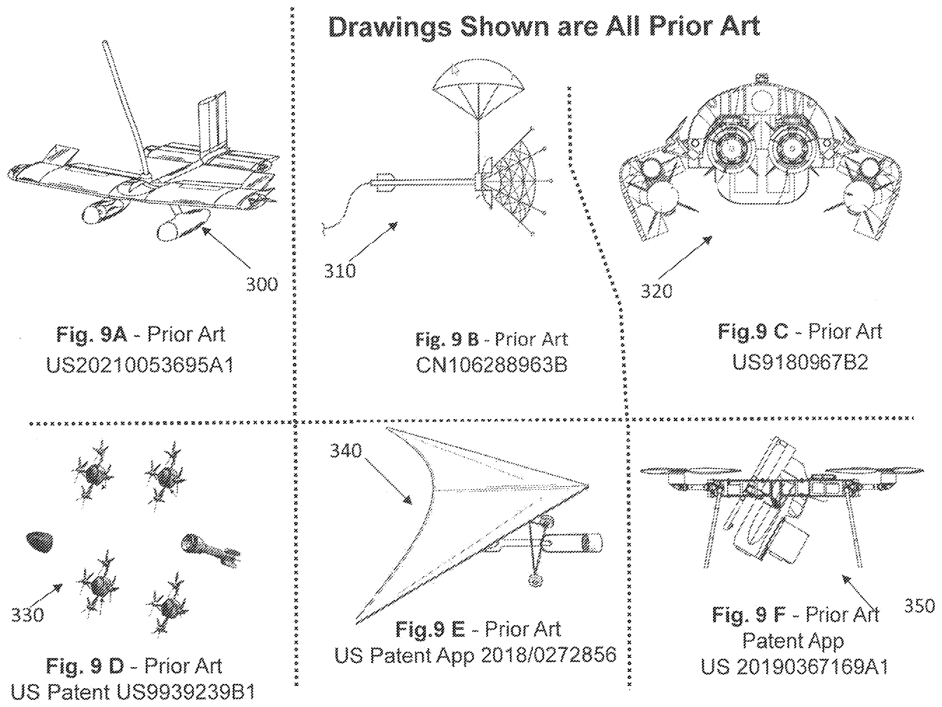

FIGS. 9A through 9 F are sketches of prior art for ArcSpear Electric Jet Drone System 30. These include: prior Art 300 US20210053695A1 by Marinus Bernard Bosma in 2020 called a Fire bomber delivery; prior Art 310 CN106288963B assigned to Disco Corp in 2016 called a Small-sized unmanned aerial vehicle driving and reversing device; prior Art 320 U.S. Pat. No. 9,180,967B2 by Binkholder issued in 2012 and entitled a Configurable pod structure and store stowage and deployment system and method; prior Art 330 US Patent U.S. Pat. No. 9,939,239B1 issued to Manole in 2013 named a Stackable Collaborative engagement munition; prior Art 340 US Patent Application 2018/0272856 by Manning done in 2018 and called a DUCTED FAN PROPULSION SYSTEM; and prior Art 350 US Patent Application US 20190367169A1 completed around 2019 by O'Leary and named an Unmanned flying grenade launcher. As can be seen, the compact and lightweight drone delivery device 30 called an ArcSpear Electric Jet Drone System having an electric ducted air propulsion system and being relatively difficult to track in flight is both a unique combination and use as described herein.

The anticipated materials for the compact and lightweight drone delivery device 30 called an ArcSpear Electric Jet Drone System include: a group of fabric material for the flexible belt 146 can be nylon, rayon, cotton, polyester, leathers, vinyl, and synthetic or non-synthetic composite materials. The characteristics preferred are a fabric which is flexible, comfortable, strong, cut-resistant, lightweight, and easy to clean. The method to attach the belt and harnesses to the frame 71 or to each other may be sewing, clips, rivets, or various fasteners. The propellers 51 may be a metal such as steel, steel alloy, aluminum, titanium; a composite material; a wood laminate, or other durable, light weight yet sufficiently sturdy material. Propellers are well known in the art of aircraft and may be selected from a plethora of styles and materials. The other components are likewise expected to be of lightweight, strong, and durable materials shaped to appropriate configurations. However, these are exemplary and lot limitations to other means which are well within the spirit and scope of the full embodiment of the compact and lightweight drone delivery device 30 called an ArcSpear Electric Jet Drone System. The entire propeller driven system, as just described, rotates around the fixed shaft which can have an aperture (hollow opening) throughout its center. The various control wiring is often guided along and through the structure as is well known in the art of lightweight aircraft. Additionally, a mount for the motor (s) 78 are normally retained by a collar to the shaft. The battery (ies) 74 are connected through cables and wire harnesses to the motor (s). The electric power from the battery powers the motor which transforms the stored electrical energy into kinetic energy and rotational power. This power is further transferred to the propellers and the system shown or a functional equivalent. The motors 78 have relatively simple Electric Speed Controllers (ESC) and controls 90 as one skilled in the art of electromechanical power systems well appreciates. The remote-control system and controller 95 for operation of the drone can be one of many well-known to the drone industry and aircraft operations. These are used in combination with readily available 3-D goggles 92 of operator 100 with signals to/from camera 82. As stated, this means of using a remote system is also well known to those skilled in the art of electrical and electronic remote-control systems. The remaining shrouds and mechanical structures can be of various materials—steel, steel alloys, titanium, aluminum, and composite metals, etc. The general components were identified above.

The frame structures 71, 71A may be of a variety of configurations but the preferred is a flat plate-like shape. The materials for example and not limitation may be a metal like steel, a steel alloy, aluminum, titanium, a composite plastic, plastic filled with carbon fibers, or any other light weight, durable material. However, these materials mentioned are exemplary and lot limitations to other means which are well within the spirit and scope of the full embodiment of the device 30. The batteries 74 are connected generally through cables and harnesses and generally to a central battery block then through the ESCs 80 and to the motor (s) 78. The electric power from the battery powers the motor which transforms the stored electrical energy into kinetic energy and rotational power. This power is further transferred to the propellers and the system shown or a functional equivalent. The motors 78 and battery 74 system have relatively simple electronic speed controllers (ESC) 90 flight controllers 80 as one skilled in the art of electromechanical power systems well appreciates.

This system anticipates several types of rechargeable battery 74 back including but not limited to: Nickle Cadmium batteries, Nickle Metal Hydride batteries, Lithium-Ion batteries, Small and sealed lead acid batteries. These may be Absorbed glass mat (AGM) battery or gel battery (“gel cell”). Other experimental types include Lithium sulfur, Sodium-ion, Thin film lithium, Zinc-bromide, Zinc-cerium, Vanadium redox, Sodium-sulfur, Molten salt, and Silver-zinc. One skilled in the art of rechargeable batteries also anticipates and fully expects other battery types to be developed which will function well and be within the scope and breadth of this invention. Voltages of the system may also vary.

The details mentioned here are exemplary and not limiting. Other specific components and manners specific to describing a compact and lightweight drone delivery device 30 called an ArcSpear Electric Jet Drone System may be added as a person having ordinary skill in the field of the art of propulsion systems for small aircraft well appreciates.

### OPERATION OF THE PREFERRED EMBODIMENT

The compact and lightweight drone delivery device 30 called an ArcSpear Electric Jet Drone System having an electric ducted air propulsion system and being relatively difficult to track in flight has been described in the above embodiment. The manner of how the device operates is described below. One notes well that the description above and the operation described here must be taken together to fully illustrate the concept of the compact and lightweight drone delivery device called an ArcSpear Electric Jet Drone System. The preferred embodiment of the compact and lightweight drone delivery device 30 called an ArcSpear Electric Jet Drone System comprised of: (a) a frame system 71; (b) a ducted turbine system comprising at least one and preferably four turbine 50 with a set of blades or impellers 51 of the fan/turbine 50, a shroud/exterior protection and frame 55 of the turbine/fan 50, a cut protector 55A on shroud 55, a means 56 to secure shroud 55, and an electric motor 78 with each fan 50 the device 30 with shaft 58 connected to blades 51; (c) a payload 110 with a deployment means 115 on the structural frame 71; (d) a power system comprising a set of rechargeable batteries 74, a means to removably secure the batteries 74 to the frame 71, a wiring harness from batteries 74 to motors 78, a recharge plug 79 to batteries 74 from recharging power source 89, and a recharging power source 89; and (e) a flight controller 80 for powering the ESC 90 and controlling the motor 78 plus a set of connectors 85 from the set of batteries 74 to the motor 78 wherein the device 30 having an electric ducted air propulsion system, being relatively difficult to track in flight (stealth), being relatively fast, able to maneuver quickly and able to refuse the device to repeat and carry payloads after recharging and replenishing the payload.

The compact and lightweight drone delivery device 30 called an ArcSpear Electric Jet Drone System functions as follows: The electric fans and motors devices 50, 78 are compact, lightweight and may be ducted with carbon-fiber or other lightweight material ducts. Motors are connected to electronic speed controllers and powered by the batteries and then managed through a throttle 80, which is managed by a user/operator 100 through the controller 95 which are connected and control the flight controller 80. The operator 100 monitors visually through the goggles 92 that are connected by antenna 81 to the camera 82. The power from the batteries 74 are controlled by the flight controller 80 and operate the ESC 90 to each of the motors 78 and coupled ducted fans 50 to balance thrust to each fan 50 and thus control the speed and thrust of each fan motor 78 and limits roll from side to side. By increasing and decreasing the fan motors speed by controlling the electrical power, the thrust of each fan is controlled and the drone 30 can be moved and guided by the resultant thrust of each fan. The drone 30 is guided to a target 150 by the operator 100 and then the payload 110 is activated/dropped/deployed by the payload controller 115 activated by the operator 100 on the controller 95.

FIGS. 8A through 8 D are sketches of a ArcSpear device 30,31,33 in operation and the tactical process 35. In these use drawings are:

| Step | ArcSpear Tactics 35 |
|---|---|
| A | ArcSpear loads at Home w/Payload - Charged Explosive |
| B | ArcSpear Swoops to location |
| C | ArcSpear Drops Explosive |
| D | ArcSpear Swoops Away |
| E | ArcSpear Returns to Home |
| | Reload and Repeat |

Shown in these figures are: a compact and lightweight drone delivery device 30 called an ArcSpear Electric Jet Drone System having an electric ducted air propulsion system and being relatively difficult to track in flight; a prototype 31 of compact and lightweight drone delivery device 30 called an ArcSpear Electric Jet Drone System; a flight 33 of the prototype 31 of the ArcSpear Electric Jet Drone System 30; a tactical process 35 of the compact and lightweight drone delivery device 30 called an Arc Spear; a payload 110 which can be various goods 110A like medicine, food, ammunition, field supplies; weapons and munitions 110B such as explosives, grenades, rockets, tube bombs, timed discharge devices, and electronic interference devices 110C and the like; the ground or terrain 120 being flown above by ArcSpear device 30; a flightpath 130 of the ArcSpear device 30 in the tactical process 35; and a target or destination 150 of the payload 110 of the ArcSpear device 30.

Many uses are anticipated for the compact and lightweight drone delivery device called an ArcSpear Electric Jet Drone System 30 having an electric ducted air propulsion system and being relatively difficult to track in flight. Some examples, and not limitations, are shown in the following Table.

| ITEM | DESCRIPTION |
|---|---|
| 1 | Can deliver medicine and blood for first aid |
| | activities |
| 2 | Can deliver payloads of food and water for survival |
| 3 | Can deliver payloads of electrical and mechanical |
| | replacement parts for field repair to military and |
| | construction teams |
| 4 | Can deliver payloads of replacement munitions |
| 5 | Can be used as a military asset, capable of |
| | deploying munitions against targets |
| 6 | Can be used effectively in a manner that allows for |
| | extreme control in congested urban, forested, or |
| | other confined environments |
| 7 | Can be used at high speed, with a cross-section and |
| | speed that would make it extremely difficult to |
| | shoot down |

With this description it is to be understood that the compact and lightweight drone delivery device called an ArcSpear Electric Jet Drone System 30 having an electric ducted air propulsion system and being relatively difficult to track in flight is not to be limited to only the disclosed embodiment of product. The features of the System 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A compact and lightweight drone delivery device (30) called an ArcSpear Electric Jet Drone System comprised of:
(a) a frame system (71);
(b) a ducted turbine system comprising at least one turbine (50);
(c) a payload (110) with a deployment means (115 on the structural frame (71);
(d) a power system;
(e) a flight controller (80) for powering an Electric Speed Controllers (ESC) (90) and controlling the motor (78) with a set of connectors (85) from the set of batteries (74) to the motor (78); and
(f) a camera (82) and antennas (81) for receiving and sending signals from the flight controller (80) to and from an operator (100)
wherein the device (30) having an electric ducted air propulsion system, is stealth and difficult to track in flight, is relatively fast, is able to maneuver quickly, and is able to be re-used as the device and one able to repeat use of the device and the device is able to carry payloads after the power source is recharged and the payload is replenished.

2. The compact and lightweight drone delivery device (30) called an ArcSpear Electric Jet Drone System described in claim 1 wherein the power system is comprising a set of rechargeable batteries (74), a means to removably secure the batteries (74) to the frame (71), a wiring harness from batteries 74 to motors (78), a recharge plug (79) to batteries (74) from recharging power source (89), and a recharging power source (89).

3. The compact and lightweight drone delivery device (30) called an ArcSpear Electric Jet Drone System described in claim 2 wherein the at least one turbine is comprised of four turbines.

4. The compact and lightweight drone delivery device (30) called an ArcSpear Electric Jet Drone System described in claim 3 wherein each turbine further comprises a set of blades or impellers (51) of the fan/turbine (50), a shroud/exterior protection and frame (55) of the turbine/fan (50), a cut protector (55A) on shroud (55), a means (56) to secure shroud (55), and an electric motor (78) with each fan (50) the device (30) with shaft (58) connected to blades (51).

5. The compact and lightweight drone delivery device (30) called an ArcSpear Electric Jet Drone System described in claim 4 wherein the device would carry up to 20 lbs. of payload at high speed per 10 lbs. of total aircraft weight.

6. The compact and lightweight drone delivery device (30) called an ArcSpear Electric Jet Drone System described in claim 4 wherein the device could have commonly available drone stability using multiple gyroscopes on a standard multi-copter flight controller.

7. The compact and lightweight drone delivery device (30) called an ArcSpear Electric Jet Drone System described in claim 4 wherein the device can be used effectively as a military asset, is capable of deploying munitions against targets in a manner that allows for extreme control in congested urban, forested, or other confined environments, can deploy a payload at high speed, and has a cross-section and speed that is extremely difficult to shoot down.

8. The compact and lightweight drone delivery device (30) called an ArcSpear Electric Jet Drone System described in claim 4 wherein the device is relatively inexpensive so it is economical to be used once or can be reused, based on pending mission requirements.

9. The compact and lightweight drone delivery device (30) called an ArcSpear Electric Jet Drone System described in claim 4 wherein the device (30) could fly at speeds up to or above 180 mph.

10. The compact and lightweight drone delivery device (30) called an ArcSpear Electric Jet Drone System described in claim 4 wherein the device (30), including a transmission and control system fit in a backpack/small suitcase, is extremely portable and can be carried by a single person.

11. The compact and lightweight drone delivery device (30) called an ArcSpear Electric Jet Drone System described in claim 4 wherein the device (30) is safe and quiet to operate because of the protected, ducted turbine blades.

12. The compact and lightweight drone delivery device (30) called an ArcSpear Electric Jet Drone System described in claim 4 wherein the device (30) utilizes electric jet turbine engines with 10:1 or greater thrust to weight ratio, such that for every one pound of engine plus ESC combined weight, the entire device, without a weight for batteries, produces at least 10 pounds of thrust.

13. The compact and lightweight drone delivery device (30) called an ArcSpear Electric Jet Drone System described in claim 4 wherein the device can be supplemented for power with a quick-change propulsion pack (140) with multiple batteries (74) secured around the fan shrouds (55) of fans (50).

14. The compact and lightweight drone delivery device (30) called an ArcSpear Electric Jet Drone System described in claim 4 wherein the frame system (71) is comprised of a durable material that is selected from the group consisting of steel, a steel alloy, aluminum, titanium, a composite plastic, plastic filled with carbon fibers.

15. The compact and lightweight drone delivery device (30) called an ArcSpear Electric Jet Drone System described in claim 4 wherein the means (56) to secure shroud (55) is selected from the group consisting of fasteners, molding, casting, welding, brazing, and adhesives.

16. The compact and lightweight drone delivery device (30) called an ArcSpear Electric Jet Drone System described in claim 4 wherein the set of rechargeable batteries (74) is selected from the group consisting of Nickle Cadmium batteries, Nickle Metal Hydride batteries, Lithium-Ion batteries, sealed lead acid batteries, Lithium sulfur batteries, Sodium-ion batteries, Thin film lithium batteries, Zinc-bromide batteries, Zinc-cerium batteries, Vanadium redox batteries, Sodium-sulfur batteries, Molten salt batteries, and Silver-zinc.

17. A compact and lightweight drone delivery device (30) called an ArcSpear Electric Jet Drone System comprised of:
(a) a frame system (71);
(b) a ducted turbine system comprising at least four turbines (50), each turbine with a set of blades or impellers (51) of the fan/turbine (50), a shroud/exterior protection and frame (55) of the turbine/fan (50), a cut protector (55A) on shroud (55), a means (56) to secure shroud (55), and an electric motor (78) with each fan (50) the device (30) with shaft (58) connected to blades (51);
(c) a payload (110) with a deployment means (115 on the structural frame (71);
(d) a power system comprising a set of rechargeable Lithium-Ion batteries (74), a means to removably secure the batteries (74) to the frame (71), a wiring harness from batteries 74 to motors (78), a recharge plug (79) to batteries (74) from recharging power source (89), and a recharging power source (89); and
(e) a flight controller (80) for powering an Electric Speed Controllers (ESC) (90) and controlling the motor (78) with a set of connectors (85) from the set of batteries (74) to the motor (78); and
(f) a camera (82) and antennas (81) for receiving and sending signals from the flight controller (80) to and from an operator (100)
wherein the device (30) having an electric ducted air propulsion system, is stealth and difficult to track in flight, is relatively fast, is able to maneuver quickly, and is able to be re-used as the device and one able to repeat use of the device and the device is able to carry payloads after the power source is recharged and the payload is replenished.

18. The compact and lightweight drone delivery device (30) called an ArcSpear Electric Jet Drone System described in claim 17 wherein the frame system (71) is comprised of a durable material that is selected from the group consisting of steel, a steel alloy, aluminum, titanium, a composite plastic, plastic filled with carbon fibers.

19. The compact and lightweight drone delivery device (30) called an ArcSpear Electric Jet Drone System described in claim 17 wherein the means (56) to secure shroud (55) is selected from the group consisting of fasteners, molding, casting, welding, brazing, and adhesives.

20. The compact and lightweight drone delivery device (30) called an ArcSpear Electric Jet Drone System described in claim 17 wherein the set of rechargeable batteries (74) is selected from the group consisting of Nickle Cadmium batteries, Nickle Metal Hydride batteries, Lithium-Ion batteries, sealed lead acid batteries, Lithium sulfur batteries, Sodium-ion batteries, Thin film lithium batteries, Zinc-bromide batteries, Zinc-cerium batteries, Vanadium redox batteries, Sodium-sulfur batteries, Molten salt batteries, and Silver-zinc.
